(19) United States
(12) Patent Application Publication
(10) Pub. No.: US 2025/0004203 A1
(43) Pub. Date: Jan. 2, 2025

(54) TECHNOLOGIES FOR BEAM EXPANSION IN MONOLITHIC GLASS SUBSTRATES

(71) Applicant: Intel Corporation, santa Clara, CA (US)

(72) Inventors: Jianyong Mo, Chandler, AZ (US); Fan Fan, Chandler, AZ (US); Liang Zhang, Chandler, AZ (US)

(73) Assignee: Intel Corporation, Santa Clara, CA (US)

(21) Appl. No.: 18/342,289

(22) Filed: Jun. 27, 2023

(51) Int. Cl. G02B 6/26; G02B 3/00

(52) U.S. Cl. CPC G02B 6/262; G02B 3/0087

(57) ABSTRACT

Technologies for beam expansion in monolithic glass substrates are disclosed. In an illustrative embodiment, lenses in a glass substrate may be formed using a laser, either by changing the index of refraction or as part of a two-step etching process. A seam may be prepared and etched, separating the glass substrate into two components, one of which will be part of an optical plug and one of which will be part of an optical receptacle. The optical plug has a cavity into which an optical fiber can be placed. In use, the lens in the glass substrate of the optical plug collimates light from the optical fiber into a beam. When the optical plug is mated with the optical receptacle, the beam is aligned to the lens and a waveguide in the optical receptacle. The large size of the beam relaxes the alignment tolerance for the optical plug and receptacle.

### BACKGROUND

Photonic integrated circuits (PICs) can be used for several applications, such as communications. Efficiently and cheaply aligning optics to couple light into and out of PICs can be a challenge. Approaches such as the attachment of optical fiber arrays to PICS may be slow, may be incompatible with conventional semiconductor packaging processes, and can result in substantial yield and throughput issues.

### BRIEF DESCRIPTION OF THE DRAWINGS

FIG. 1 is an isometric view of a system including an optical fiber plug plugged into an assembly with a glass substrate, a photonic integrated circuit (PIC) die, and an electrical integrated circuit (EIC) die mounted on it.

FIG. 2 is a top-down view of the system of FIG. 1.

FIG. 3 is a cross-sectional view of one embodiment of the system of FIG. 1.

FIG. 4 is a cross-sectional view of one embodiment of the system of FIG. 1.

FIG. 5 is a simplified flow diagram of at least one embodiment of a method for manufacturing a system including an optical plug and an optical receptacle for the optical fiber plug.

FIG. 6 is a glass substrate at one stage of one embodiment of the method of FIG. 5.

FIG. 7 is a glass substrate at one stage of one embodiment of the method of FIG. 5.

FIG. 8 is a glass substrate at one stage of one embodiment of the method of FIG. 5.

FIG. 9 is a glass substrate at one stage of one embodiment of the method of FIG. 5.

FIG. 10 is a glass substrate at one stage of one embodiment of the method of FIG. 5.

FIG. 11 is a glass substrate and PIC die at one stage of one embodiment of the method of FIG. 5.

FIG. 12 is a glass substrate and PIC die at one stage of one embodiment of the method of FIG. 5.

FIG. 13 is a top view of a wafer and dies that may be included in a microelectronic assembly, in accordance with any of the embodiments disclosed herein.

FIG. 14 is a cross-sectional side view of an integrated circuit device that may be included in a microelectronic assembly, in accordance with any of the embodiments disclosed herein.

FIGS. 15A-15D are perspective views of example planar, gate-all-around, and stacked gate-all-around transistors.

FIG. 16 is a cross-sectional side view of an integrated circuit device assembly that may include a microelectronic assembly, in accordance with any of the embodiments disclosed herein.

FIG. 17 is a block diagram of an example electrical device that may include a microelectronic assembly, in accordance with any of the embodiments disclosed herein.

### DETAILED DESCRIPTION

In one illustrative embodiment disclosed herein, an optical plug and optical receptacle can be formed, in part, from a monolithic glass substrate. The optical plug and/or optical receptacle may include lenses to collimate light from and/or focus light into optical fibers and/or waveguides. In an illustrative embodiment, the lenses are integral to the monolithic glass substrate and are formed at the same time, improving alignment between the lenses.

In some embodiments, some or all of the features of the optical plug and/or optical receptacle can be created using lasers. For example, a laser may be used to modify the index of refraction of the glass substrate, forming a waveguide and/or lens in the glass substrate. Additionally or alternatively, a laser may be used to perform selective laser-induced etching to selectively remove part of the glass substrate, forming features such as a cavity for an optical fiber, alignment features for a photonic integrated circuit (PIC) die, or lenses on a surface of the optical plug and/or optical receptacle.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

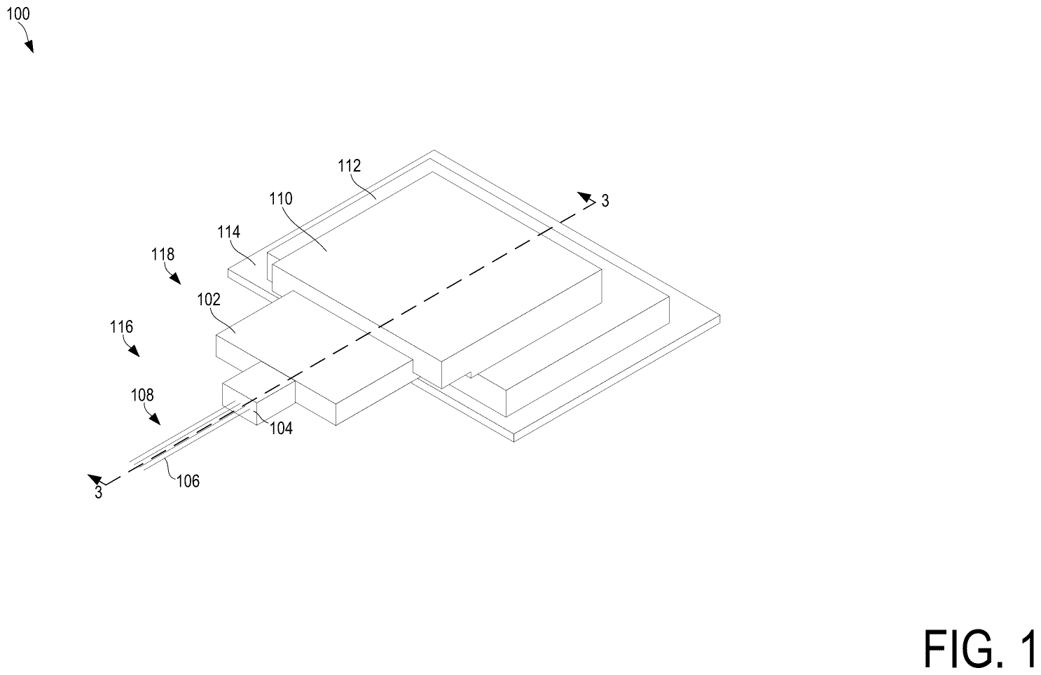

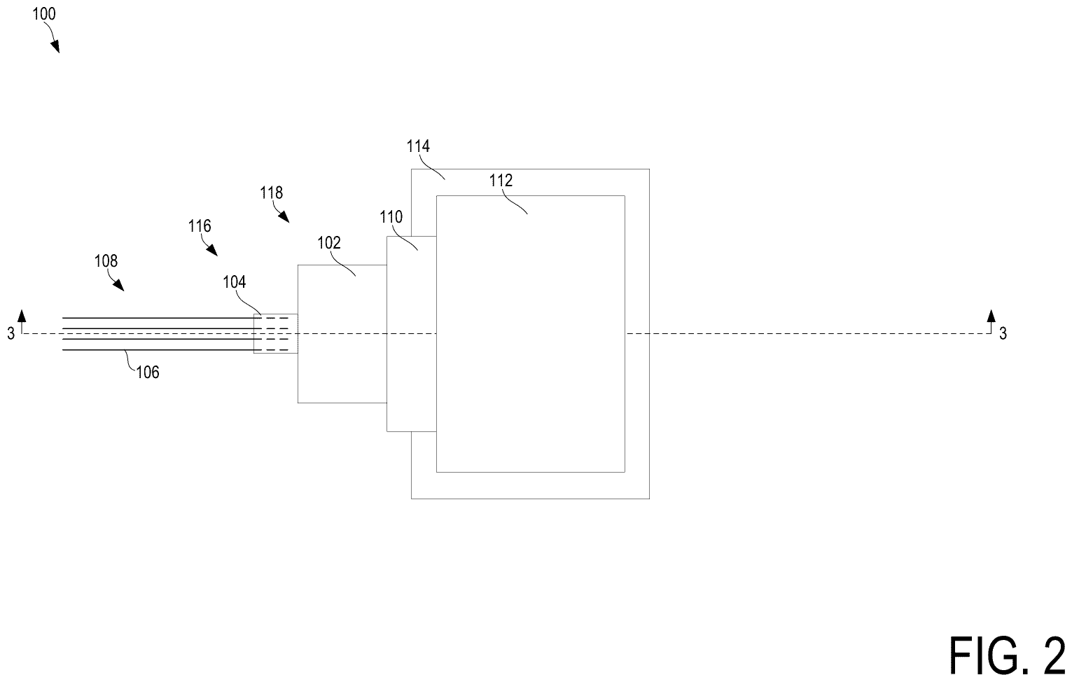

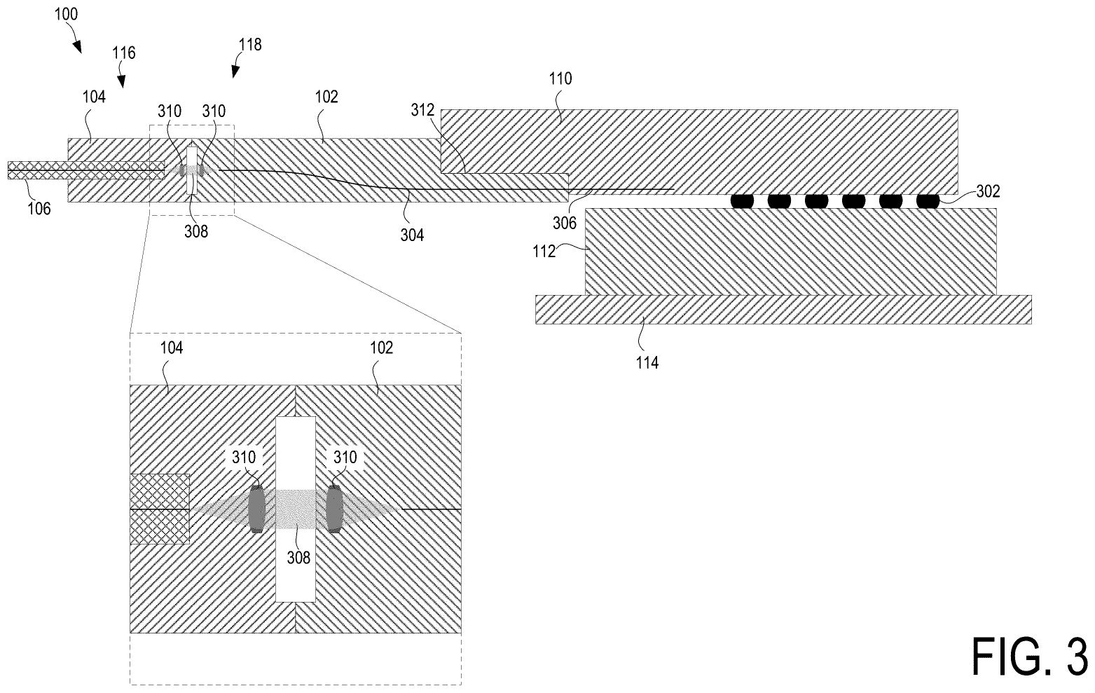

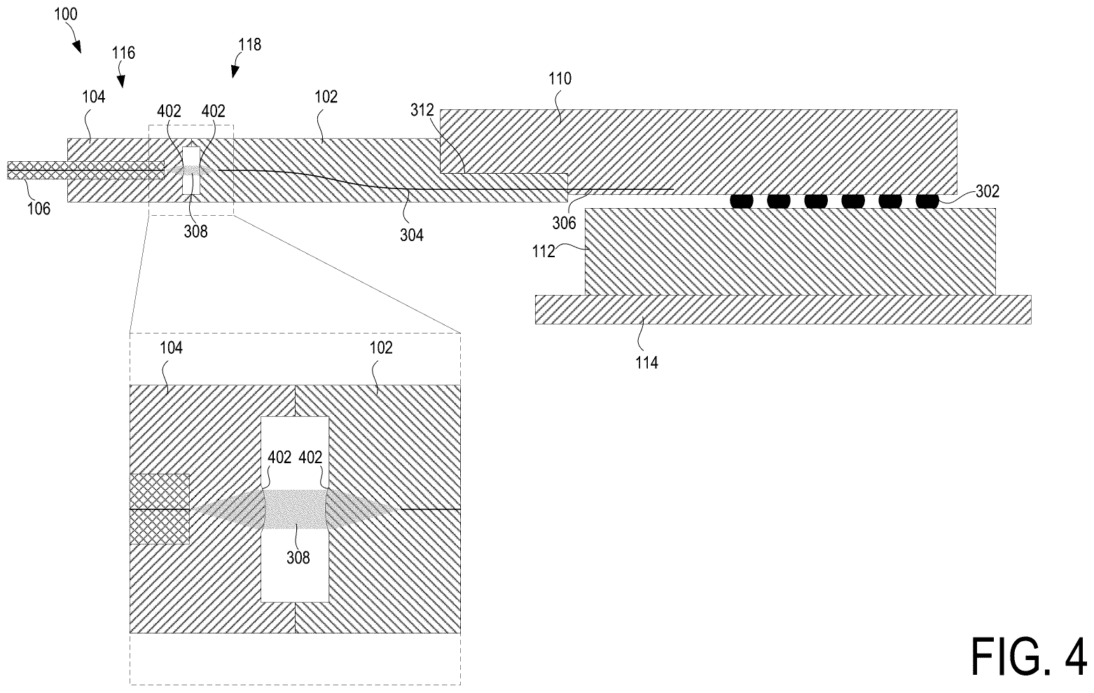

Referring now to FIGS. 1-4, in one embodiment, a system 100 includes an optical plug 116, an optical receptacle 118, a photonic integrated circuit (PIC) die 110, an electronic integrated circuit (PIC) die 112, and a circuit board 114. FIG. 1 shows a perspective view of the system 100, FIG. 2 shows a top-down view of the system 100, FIG. 3 shows a cross-sectional view of one embodiment of the system 100, and FIG. 4 shows a cross-sectional view of one embodiment of the system 100. In an illustrative embodiment, the optical receptacle 118 includes a glass substrate 102. The glass substrate 102 is mounted on the PIC die 110, the PIC die 110 is mounted on the EIC die 112, and the EIC die 112 is mounted on the circuit board 114. In the illustrative embodiment, the optical plug 116 is mated with the optical receptacle 118. An array 108 of optical fibers 106 is connected to a glass substrate 104 of the optical plug 116.

In one embodiment, as shown in FIG. 3, each optical fiber 106 is positioned within a cavity defined in the glass substrate 104. Each optical fiber 106 is aligned to a lens 310 defined in the glass substrate 104. The glass substrate 104 includes an array of lenses 310 extending into and out of the page, as seen from the perspective of FIG. 3. The region of the glass substrate 104 corresponding to the lens 310 has a different index of refraction as the bulk of the glass substrate 104. The lens 310 may be embodied as a region with a fixed difference in index of refraction relative to the bulk of the glass substrate 104, with one or more curved surfaces that collimate light from the optical fiber 106 and/or focus light into the optical fiber 106. Additionally or alternatively, the lens 310 may be embodied as a region with a range of different indices of refraction, such as a graded-index (or GRIN) lens. The optical receptacle 118 has, for each optical fiber 106, a corresponding lens 310 defined in the glass substrate 102 as well as a waveguide 304 defined in the glass substrate 102.

In an illustrative embodiment, light from each optical fiber 106 can be collimated by the lens 310 in the optical plug 116 to a beam 308. The beam 308 can then be focused by the lens 310 in the optical receptacle 118 to the waveguide 304. In some embodiments, there may be a cavity defined between the glass substrate 104 and the glass substrate 102, with the beam 308 passing through air between the glass substrate 104 and the glass substrate 102, as shown in FIG. 3. In other embodiments, there may not be a cavity, and the beam 308 may pass directly from the glass substrate 104 to the glass substrate 102.

In another embodiment, as shown in FIG. 4, each optical fiber 106 is aligned to a lens 402 defined in a surface of the glass substrate 104. The glass substrate 104 has a curved surface, forming the lens 402 that can collimate light from the optical fiber 106 or focus light into the optical fiber 106. The optical receptacle 118 has, for each optical fiber 106, a corresponding lens 402 defined in the surface of the glass substrate 102 as well as a waveguide 304 defined in the glass substrate 102. The waveguide 304 begins at a point in the glass substrate 102 such the lens 310 focuses the collimated beam 308 into the waveguide 304.

Similar to the lenses 310 described above, in an illustrative embodiment, light from each optical fiber 106 can be collimated by the lens 402 in the optical plug 116 to a beam 308. The beam 308 can then be focused by the lens 402 in the optical receptacle 118 to the waveguide 304. In the illustrative embodiments described above, the optical plug 116 and the optical receptacle 118 both use either the bulk lenses 310 defined in the glass substrates 102, 104 or the lenses 402 defined in the surface of the glass substrates 102, 104. Additionally or alternatively, the optical plug 116 and the optical receptacle 118 may use different lenses 310, 402 and/or may use combinations of both lenses 310, 402, either for different optical fibers 106 or for the same optical fiber 106, to increase total focusing strength.

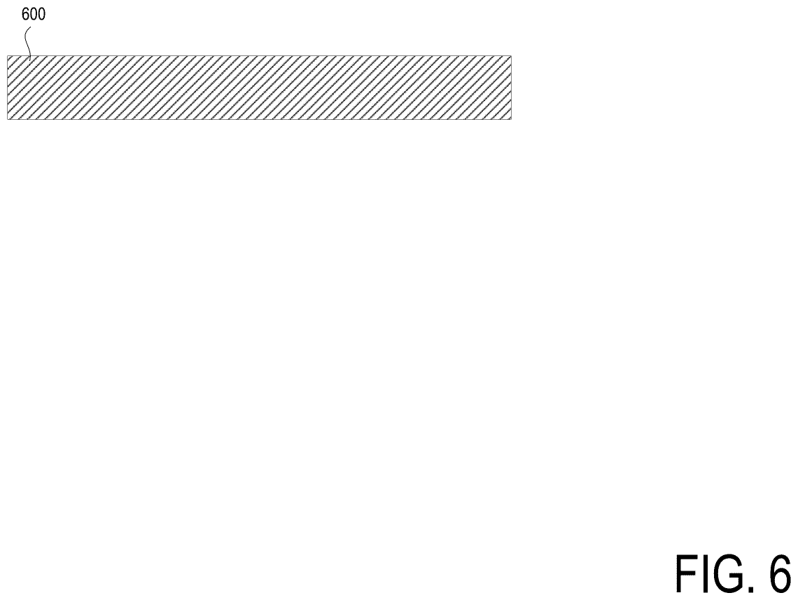

It should be appreciated that, for both the lenses 310 shown in FIG. 3 and the lenses 402 shown in FIG. 4, the lenses 310, 402 are monolithic with respect to the rest of the corresponding glass substrate 104, 102. As discussed in more detail below, the lenses 310 can be formed using ultrafast lasers to directly write the lenes 310 and/or the waveguides 304 into the glass substrates 104, 102. Additionally or alternatively, the lenses 402 can be directly formed on the surfaces of the glass substrates 104, 102 using, e.g., two-step laser-induced etching. In an illustrative embodiment, as discussed in more detail below, the glass substrates 102, 104 can be formed from the same parent glass substrate 600 (see FIG. 6). Lasers can be used to form the structures such as the lenses 310, 402 and waveguides 304 in the same period of time on the same bulk glass substrate 600, reducing or eliminating potential misalignment. As the diameter of the beam 308 is much larger than the diameter of the beam in the optical fiber 106 or waveguide 304, the alignment tolerance for, e.g., 1 dB of loss is much higher with the collimated beam 308 rather than direct coupling from the optical fiber 106 to the waveguide 304. For example, if the beam 308 is expanded to a waist of 80 micrometers from a waist of 9 micrometers in the optical fiber 106, for a 1 dB loss, the translational alignment tolerance can be relaxed from about 2 micrometers to about 20 micrometers, while the tilt tolerance is tightened down from about 2 degrees to about 0.2 degrees. Additionally, the relatively large size of the beam 308 makes coupling less sensitive to dust or other contaminants on the surface of the glass substrates 102, 104, as well as potentially improving yield.

In the illustrative embodiment, the glass substrate 102 is mated with the PIC die 110 such that waveguides 304 defined in the glass substrate 102 are aligned with and butt coupled to waveguides 306 defined in the PIC die 110. The PIC die 110 may be made of any suitable material, such as silicon. In the illustrative embodiment, the waveguides 306 may be silicon waveguides embedded in silicon oxide cladding. The PIC die 110 may include any suitable number of waveguides 306, such as 1-1,024. In the illustrative embodiment, the waveguides 306 in the PIC die 110 are edge-coupled to the waveguides 304. In other embodiments, the waveguides 304 may be coupled to the waveguides 306 in a different manner, such as using evanescent coupling or vertical coupling.

At an interface between the glass substrate 102 and the PIC die 110, one or more alignment features 312 may be present. The alignment features 312 may include, e.g., V-grooves in the glass substrate 102 and PIC die 110 to align the glass substrate 102 relative to the PIC die 110. The alignment features 312 also align the waveguides 304 in the glass substrate 102 to the waveguides 306 in the PIC die 110.

The PIC die 110 is configured to generate, detect, and/or manipulate light. The PIC die 110 may include active or passive optical elements such as splitters, couplers, filters, optical amplifiers, lasers, photodetectors, modulators, etc. The PIC die 110 may send and receive electric signals to and from the EIC die 112 through solder bumps 302. Additionally or alternatively, the solder bumps 302 may provide power to the PIC die 110. The PIC die 110 may send and receive optical signals to and from the optical receptacle 118 and optical plug 116 through the waveguides 306.

The EIC die 112 may include any suitable electronic integrated circuit component, such as resistors, capacitors, inductors, transistors, etc. The EIC die 112 may include any suitable analog and/or digital circuitry, such as a processor, a memory, an application-specific integrated circuit (ASIC), a field-programmable gate array (FPGA), etc. In some embodiments, the system 100 may be embodied as a router, a switch, a network interface controller, and/or the like. In such embodiments, the EIC die 112 and/or the PIC die 110 may include network interface controller circuitry to process, parse, route, etc., network packets sent and received by the system 100. For example, packets may be sent over the optical fibers 106 of the optical plug 116. The packets may be received and/or processed at the PIC die 110 and/or the EIC die 112. Additionally or alternatively, packets may be sent from the PIC die 110 and/or the EIC die 112 to the optical fibers 106 in the optical plug 116, to be sent to a remote device.

The illustrative circuit board 114 may be made from ceramic, glass, and/or organic-based materials with fiberglass and resin, such as FR-4. The circuit board 114 may have any suitable length or width, such as 10-500 millimeters. The circuit board 114 may have any suitable thickness, such as 0.2-5 millimeters. The circuit board 114 may support additional components, such as additional photonic or electronic integrated circuit components, a processor unit, a memory device, an accelerator device, etc.

The illustrative glass substrates 102, 104 are silicon oxide glass. In other embodiments, the substrates 102, 104 may be made of any suitable material that may be crystalline, non-crystalline, amorphous, etc., such as fused silicon, borosilicate, sapphire, yttrium aluminum garnet, etc. The glass substrates 102, 104 may be, e.g., aluminosilicate glass, borosilicate glass, alumino-borosilicate glass, silica, fused silica. The glass substrates 102, 104 may include one or more additives, such as Al2O3, B2O3, MgO, CaO, SrO, BaO, SnO2, Na2O, K2O, SrO, P2O3, ZrO2, Li2O, Ti, and Zn. The glass substrates 102, 104 may comprise silicon and oxygen, as well as any one or more of aluminum, boron, magnesium, calcium, barium, tin, sodium, potassium, strontium, phosphorus, zirconium, lithium, titanium, and zinc. The glass substrates 102, 104 may include at least 20-40 percent silicon by weight, at least 20-40 percent oxygen by weight, and at least 5 percent aluminum by weight. For example, some embodiments of the glass substrates 102, 104 may include, e.g., at least 20-23 percent silicon and at least 20-26 percent oxygen by weight.

The glass substrates 102, 104 may have any suitable length or width, such as 10-500 millimeters. The glass substrates 102, 104 may have any suitable thickness, such as 0.2-5 millimeters. The glass substrate 102 of the optical receptacle 118 may include optical elements such as fan outs, splitters, couplers, combiners, filters, etc. In some embodiments, the glass substrate 102 may include active optical elements, such as optical amplifiers, lasers, photodetectors, modulators, etc. The optical plug 116 and/or the optical receptacle 118 may include additional components for aligning and/or retaining the optical plug 116, such as alignment grooves, clips, tabs, etc. In use, the optical plug 116 can be plugged into the optical receptacle 118. In doing so, the lenses 310, 402 are positioned to couple light from the optical fibers 106 into the waveguides 306 and vice versa. The relatively large size of the beam 308 allows for a relatively large tolerance in the displacement between the glass substrate 104 and the glass substrate 102.

The optical plug 116 may include any suitable number of optical fibers 106 and lenses 310, 402, and the glass substrate 102 may include any suitable number of waveguides 304 and lenses 310, 402, such as 1-1,024 fibers 106 and/or waveguides 304 and corresponding lenses 310, 402.

The light in the optical fibers 106 and waveguides 304, 306 may be any suitable wavelength, such as 400-2,000 nanometers. In the illustrative embodiment, the light in the optical fibers 106 and waveguides 304, 306 is, e.g., 1,200-1,600 nanometers, and, in particular, may be 1,290-1,330 nanometers. The lenses 310, 402 may collimate the light to a beam 308 of any suitable diameter, such as 20-500 micrometers, as measured at the point where the intensity of the cross-section of the beam drops to 1/e² of the peak intensity. In some embodiments, the optical fibers 106, lenses 310, 402, and waveguides 304 may be arranged in two-dimensional arrays to increase channel density.

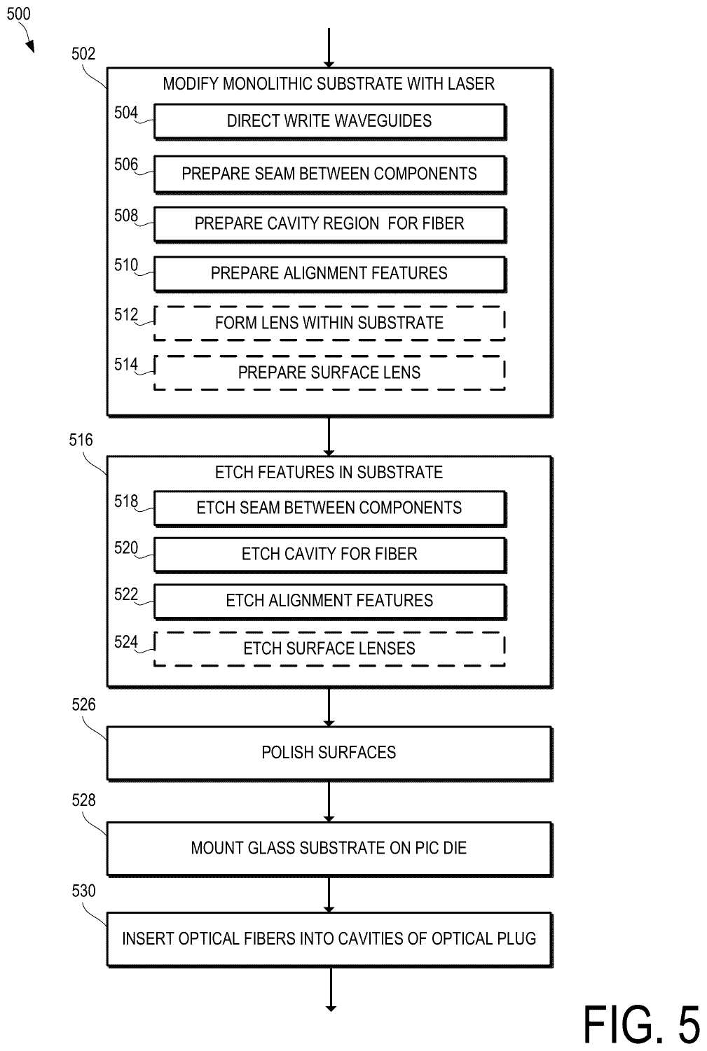

Referring now to FIG. 5, in one embodiment, a flowchart for a method 500 for creating the system 100 with an optical plug 116 and an optical receptacle 118. The method 500 may be executed by a technician and/or by one or more automated machines. In some embodiments, one or more machines may be programmed to do some or all of the steps of the method 500. Such a machine may include, e.g., a memory, a processor, data storage, etc. The memory and/or data storage may store instructions that, when executed by the machine, causes the machine to perform some or all of the steps of the method 500. The method 500 may use any suitable set of techniques that are used in semiconductor and/or photonic processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, etc. It should be appreciated that the method 500 is merely one embodiment of a method to create one embodiment of the system 100, and other methods may be used to create any suitable embodiment of the system 100. In some embodiments, steps of the method 500 may be performed in a different order than that shown in the flowchart.

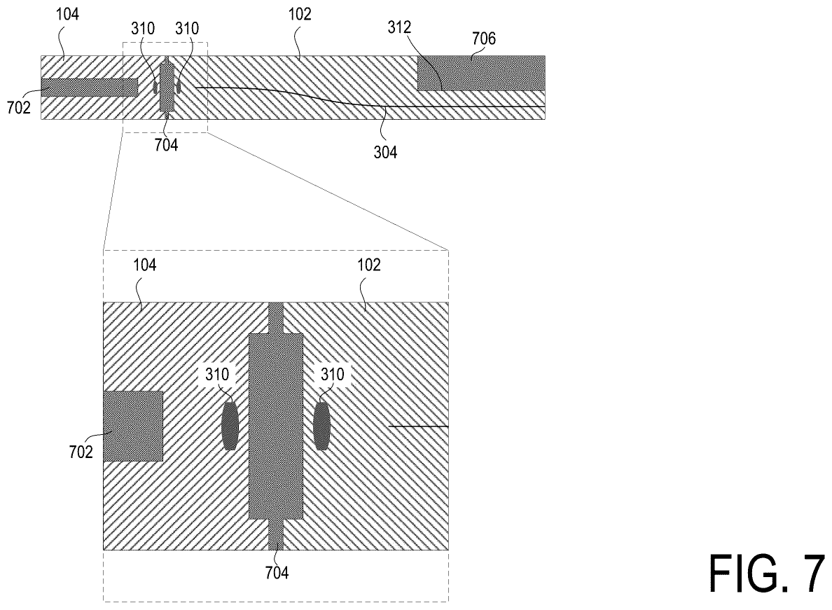

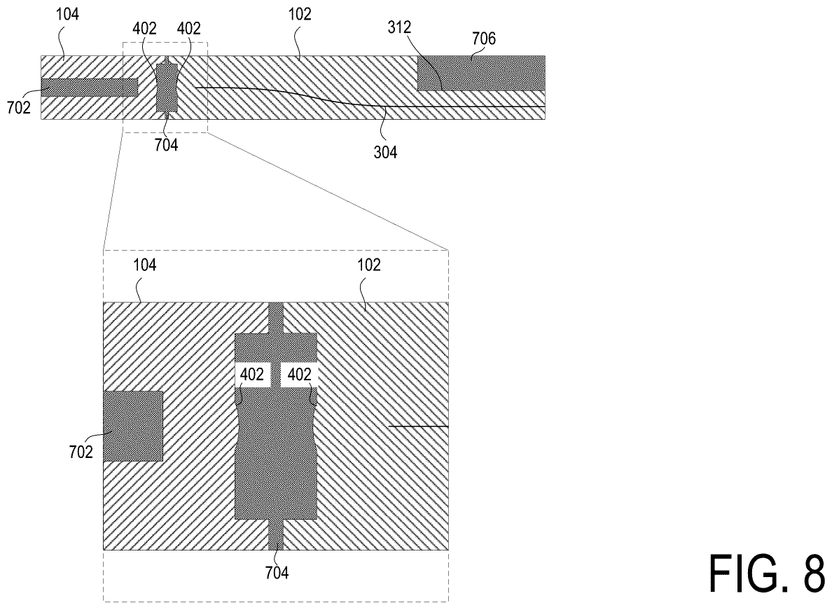

The method 500 begins in block 502, in which a monolithic glass substrate 600 is modified with one or more lasers. A monolithic glass substrate 600 is shown in FIG. 6, and a glass substrate 600 after modification is shown in FIG. 7 and FIG. 8. In block 504, waveguides 304 are directly written in the glass substrate 600, such as by using an ultrafast laser to modify the index of refraction of parts of the glass substrate 600. In block 506, a seam 704 is prepared between what will become separate glass substrates 102, 104. The seam 704 may be prepared using a laser in the first step of a two-step etching process. The laser may induce a change in a region of the glass substrate exposed to the laser to make the region more susceptible to being etched. The laser used to change the index of refraction in block 504 may be the same laser or a different laser as the one used to prepare regions such as the seam 704 for etching.

In block 508, a region 702 is prepared to generate a cavity into which a fiber 106 will be positioned. In block 510, alignment features 312 and an interface region 706 of the substrate 102 may be prepared for etching.

In block 512, in some embodiments, one or more lenses 310 may be formed in the glass substrates 102, 104, as shown in FIG. 7. The lenses 310 may be formed using a laser to modify the index of refraction of a region of the glass substrates 102, 104, similar to how the waveguides 304 may be written. The region of the lenses 310 may have a fixed difference in the index of refraction compared to the rest of the glass substrate 102, 104. Additionally or alternatively the region of the lenses 310 may have a spatially-varying difference in the index of refraction compared to the rest of the glass substrate 102, 104, allowing for a GRIN lens to be formed. For example, laser parameters such as pulse energy, pulse duration, pulse repetition rate, etc., may be varied, resulting in a variably controllable change to the index of refraction.

Additionally or alternatively, in block 514, in some embodiments, one or more lenses 402 may be prepared in the glass substrate 102, 104, as shown in FIG. 8. The seam 704 between the glass substrates 102, 104 may include a curved region that, when the seam region 704 is etched away, will form lenses 402.

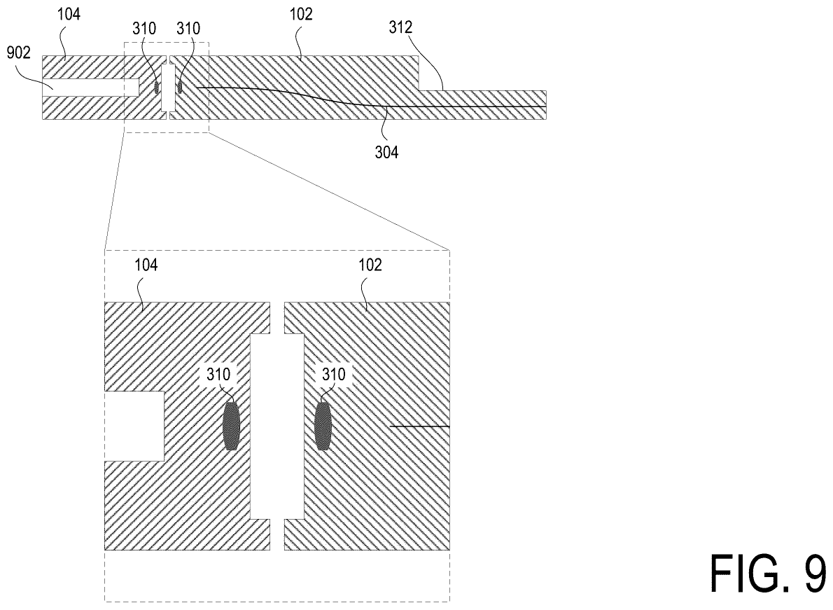

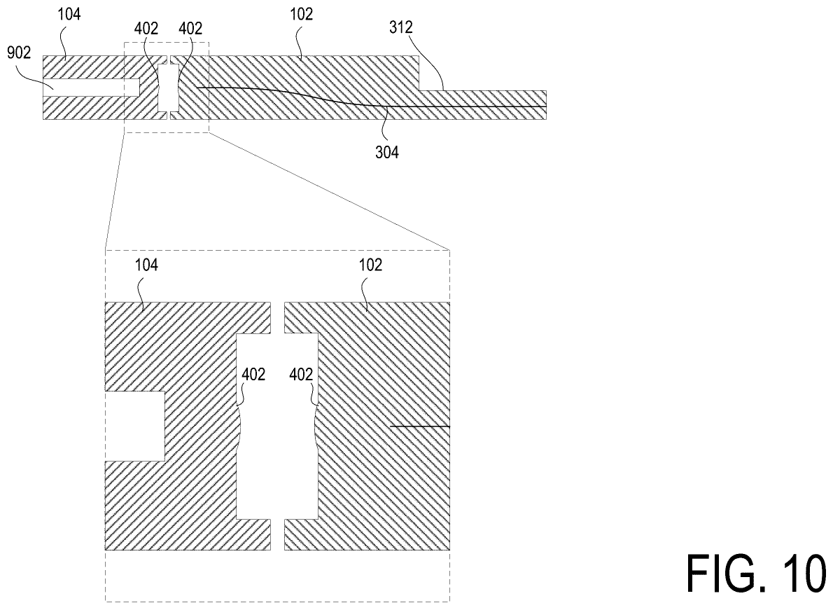

In block 516, features in the substrates 102, 104 may be etched away, as shown in FIGS. 9 and 10. In the illustrative embodiment, the seam 704 between the glass substrates 102, 104 may be etched away in block 518. Any suitable etchant may be used, such as sodium hydroxide (NaOH), potassium hydroxide (KOH), or hydrofluoric acid (HF). A cavity 902 for each optical fiber 106 may be etched in block 520. Alignment features 312 may be etched in block 522. In some embodiments, surface lenses 402 may be etched in block 524. In an illustrative embodiment, the lenses 402 on the surface of the glass substrates 102, 104 may be etched at the same time as the seam 704 in block 518. As the lenses 310 with the modified index of refraction are embedded in the glass substrates 102, 104, the etchant cannot reach them. For that reason, the lenses 310 will not be etched when the glass substrates 102, 104 are exposed to an etchant.

In block 526, the various surfaces of the substrates 102, 104 may be polished. For example, the surfaces that define the lenses 402, the surfaces in which the waveguides 304 terminate, the surfaces that define the alignment features 312, etc., may be polished. Any suitable polishing technique may be used, such as laser, mechanical, and/or chemical polishing.

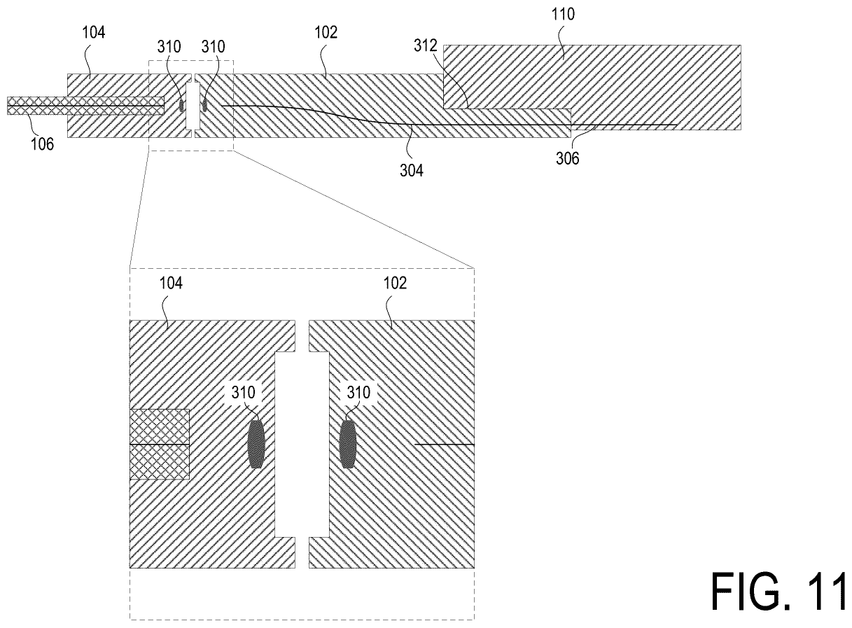

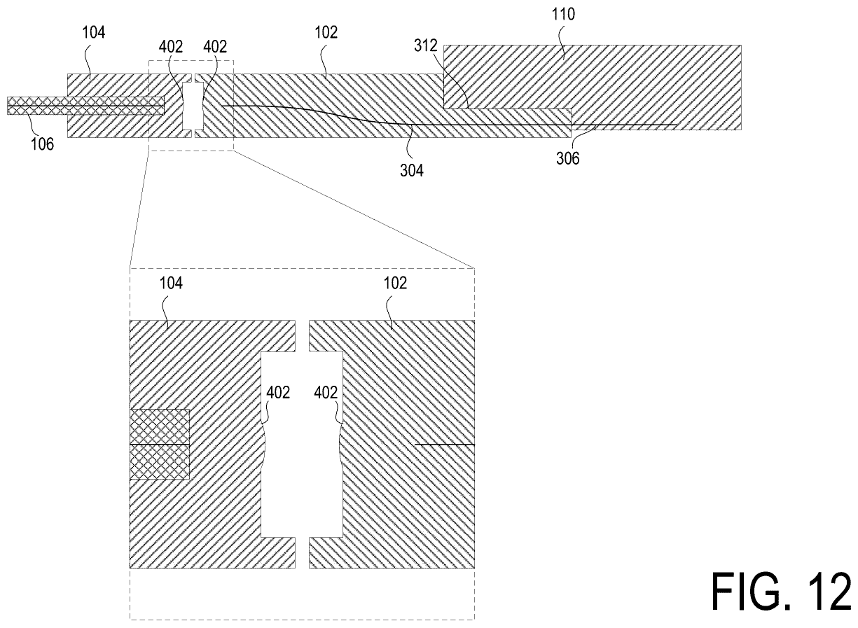

In block 528, the glass substrate 102 is mounted with the PIC die 110, as shown in FIGS. 11 and 12. In block 530, optical fibers 106 may be inserted into the cavities 902 of the glass substrate 104. The optical fibers 106 may be secured in place using, e.g., epoxy.

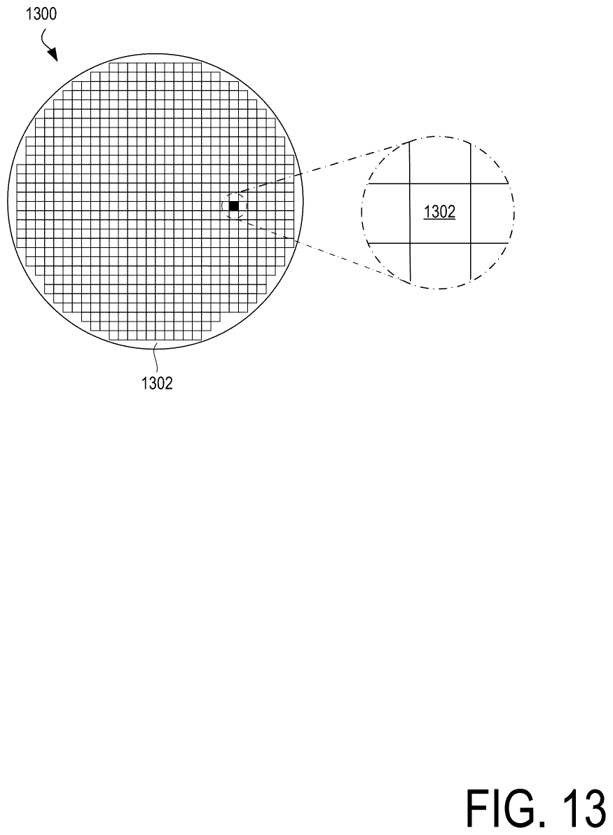

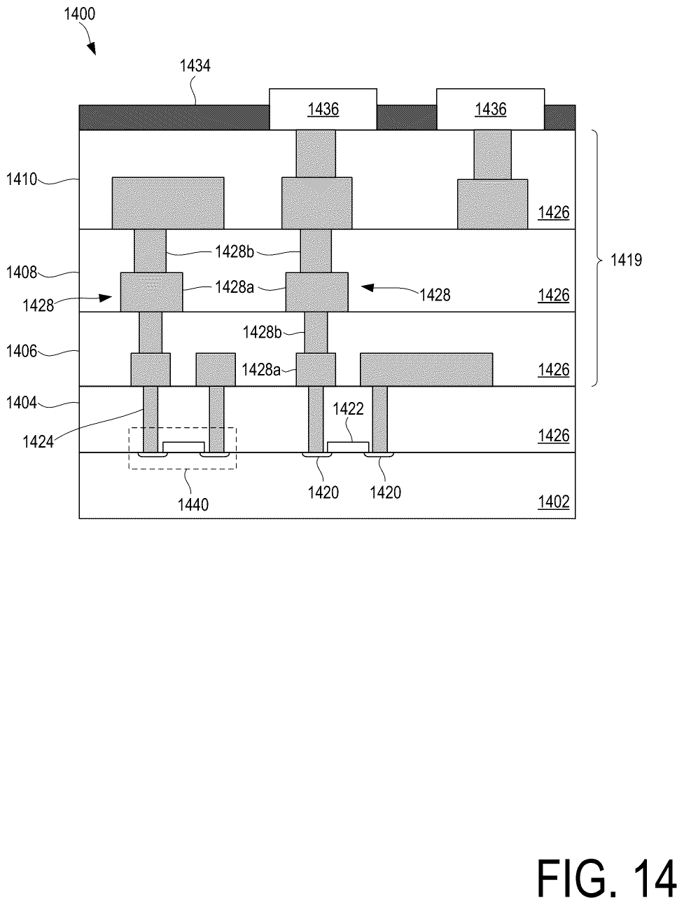

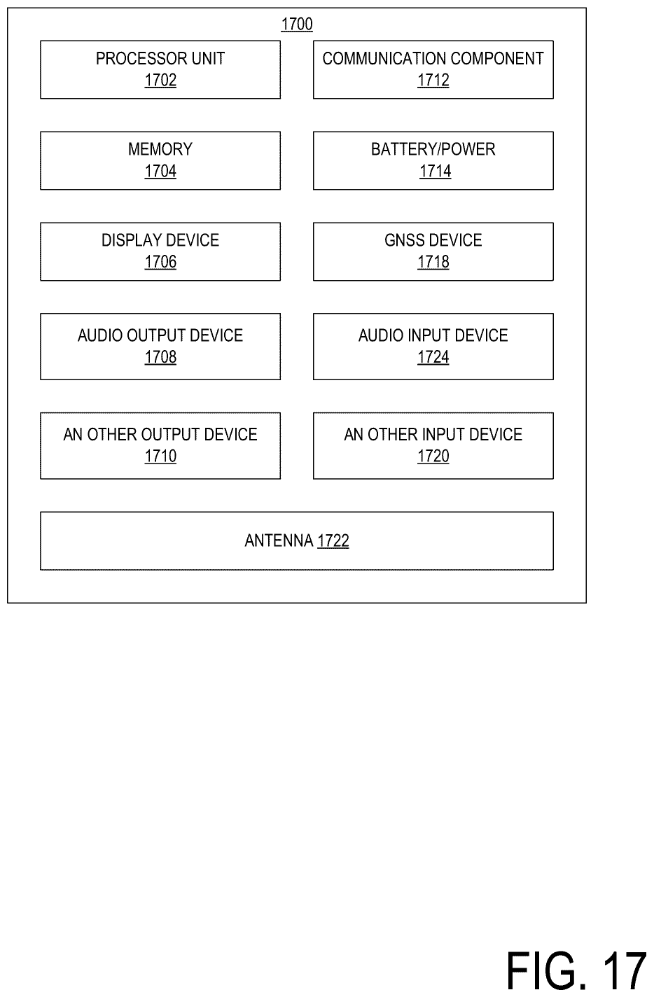

FIG. 13 is a top view of a wafer 1300 and dies 1302 that may be included in any of the systems 100 disclosed herein (e.g., as any suitable ones of the PIC dies 110 or EIC dies 112). The wafer 1300 may be composed of semiconductor material and may include one or more dies 1302 having integrated circuit structures formed on a surface of the wafer 1300. The individual dies 1302 may be a repeating unit of an integrated circuit product that includes any suitable integrated circuit. After the fabrication of the semiconductor product is complete, the wafer 1300 may undergo a singulation process in which the dies 1302 are separated from one another to provide discrete “chips” of the integrated circuit product. The die 1302 may be any of the dies 110, 112 disclosed herein. The die 1302 may include one or more transistors (e.g., some of the transistors 1440 of FIG. 14, discussed below), supporting circuitry to route electrical signals to the transistors, passive components (e.g., signal traces, resistors, capacitors, or inductors), and/or any other integrated circuit components. In some embodiments, the wafer 1300 or the die 1302 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1302. For example, a memory array formed by multiple memory devices may be formed on a same die 1302 as a processor unit (e.g., the processor unit 1702 of FIG. 17) or other logic that is configured to store information in the memory devices or execute instructions stored in the memory array. Various ones of the systems 100 disclosed herein may be manufactured using a die-to-wafer assembly technique in which some dies 110, 112 are attached to a wafer 1300 that include others of the dies 110, 112, and the wafer 1300 is subsequently singulated.

FIG. 14 is a cross-sectional side view of an integrated circuit device 1400 that may be included in any of the systems 100 disclosed herein (e.g., in any of the dies 110, 112). One or more of the integrated circuit devices 1400 may be included in one or more dies 1302 (FIG. 13). The integrated circuit device 1400 may be formed on a die substrate 1402 (e.g., the wafer 1300 of FIG. 13) and may be included in a die (e.g., the die 1302 of FIG. 13). The die substrate 1402 may be a semiconductor substrate composed of semiconductor material systems including, for example, n-type or p-type materials systems (or a combination of both). The die substrate 1402 may include, for example, a crystalline substrate formed using a bulk silicon or a silicon-on-insulator (SOI) substructure. In some embodiments, the die substrate 1402 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1402. Although a few examples of materials from which the die substrate 1402 may be formed are described here, any material that may serve as a foundation for an integrated circuit device 1400 may be used. The die substrate 1402 may be part of a singulated die (e.g., the dies 1302 of FIG. 13) or a wafer (e.g., the wafer 1300 of FIG. 13).

The integrated circuit device 1400 may include one or more device layers 1404 disposed on the die substrate 1402. The device layer 1404 may include features of one or more transistors 1440 (e.g., metal oxide semiconductor field-effect transistors (MOSFETs)) formed on the die substrate 1402. The transistors 1440 may include, for example, one or more source and/or drain (S/D) regions 1420, a gate 1422 to control current flow between the S/D regions 1420, and one or more S/D contacts 1424 to route electrical signals to/from the S/D regions 1420. The transistors 1440 may include additional features not depicted for the sake of clarity, such as device isolation regions, gate contacts, and the like. The transistors 1440 are not limited to the type and configuration depicted in FIG. 14 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

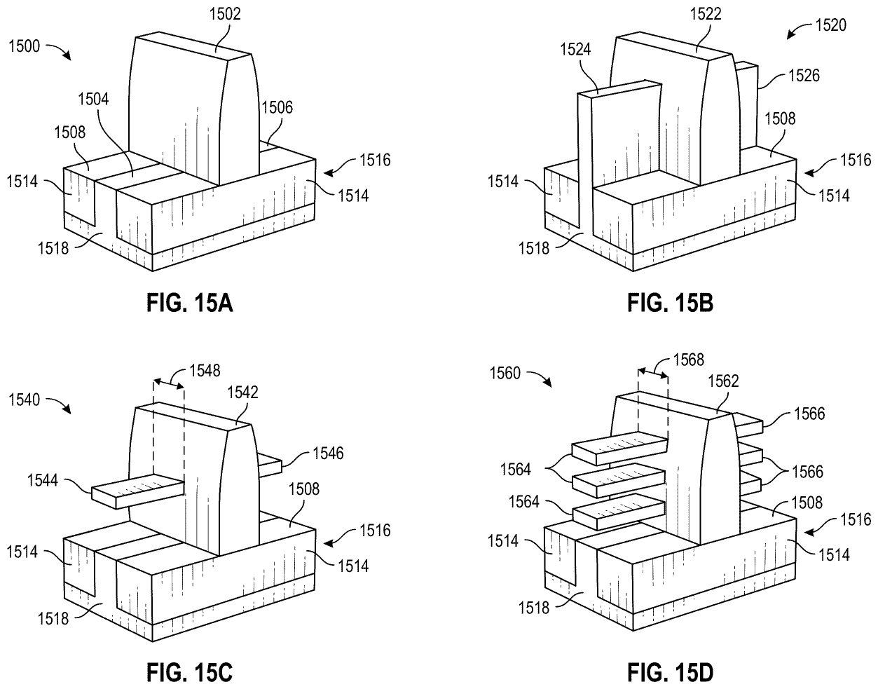

FIGS. 15A-15D are simplified perspective views of example planar, FinFET, gate-all-around, and stacked gate-all-around transistors. The transistors illustrated in FIGS. 15A-15D are formed on a substrate 1516 having a surface 1508. Isolation regions 1514 separate the source and drain regions of the transistors from other transistors and from a bulk region 1518 of the substrate 1516.

FIG. 15A is a perspective view of an example planar transistor 1500 comprising a gate 1502 that controls current flow between a source region 1504 and a drain region 1506. The transistor 1500 is planar in that the source region 1504 and the drain region 1506 are planar with respect to the substrate surface 1508.

FIG. 15B is a perspective view of an example FinFET transistor 1520 comprising a gate 1522 that controls current flow between a source region 1524 and a drain region 1526. The transistor 1520 is non-planar in that the source region 1524 and the drain region 1526 comprise “fins” that extend upwards from the substrate surface 1528. As the gate 1522 encompasses three sides of the semiconductor fin that extends from the source region 1524 to the drain region 1526, the transistor 1520 can be considered a tri-gate transistor. FIG. 15B illustrates one S/D fin extending through the gate 1522, but multiple S/D fins can extend through the gate of a FinFET transistor.

FIG. 15C is a perspective view of a gate-all-around (GAA) transistor 1540 comprising a gate 1542 that controls current flow between a source region 1544 and a drain region 1546. The transistor 1540 is non-planar in that the source region 1544 and the drain region 1546 are elevated from the substrate surface 1528.

FIG. 15D is a perspective view of a GAA transistor 1560 comprising a gate 1562 that controls current flow between multiple elevated source regions 1564 and multiple elevated drain regions 1566. The transistor 1560 is a stacked GAA transistor as the gate controls the flow of current between multiple elevated S/D regions stacked on top of each other. The transistors 1540 and 1560 are considered gate-all-around transistors as the gates encompass all sides of the semiconductor portions that extends from the source regions to the drain regions. The transistors 1540 and 1560 can alternatively be referred to as nanowire, nanosheet, or nanoribbon transistors depending on the width (e.g., widths 1548 and 1568 of transistors 1540 and 1560, respectively) of the semiconductor portions extending through the gate.

Returning to FIG. 14, a transistor 1440 may include a gate 1422 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1440 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1440 along the source-channel-drain direction, the gate electrode may consist of a U-shaped structure that includes a bottom portion substantially parallel to the surface of the die substrate 1402 and two sidewall portions that are substantially perpendicular to the top surface of the die substrate 1402. In other embodiments, at least one of the metal layers that form the gate electrode may simply be a planar layer that is substantially parallel to the top surface of the die substrate 1402 and does not include sidewall portions substantially perpendicular to the top surface of the die substrate 1402. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1420 may be formed within the die substrate 1402 adjacent to the gate 1422 of individual transistors 1440. The S/D regions 1420 may be formed using an implantation/diffusion process or an etching/deposition process, for example. In the former process, dopants such as boron, aluminum, antimony, phosphorous, or arsenic may be ion-implanted into the die substrate 1402 to form the S/D regions 1420. An annealing process that activates the dopants and causes them to diffuse farther into the die substrate 1402 may follow the ion-implantation process. In the latter process, the die substrate 1402 may first be etched to form recesses at the locations of the S/D regions 1420. An epitaxial deposition process may then be carried out to fill the recesses with material that is used to fabricate the S/D regions 1420. In some implementations, the S/D regions 1420 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1420 may be formed using one or more alternate semiconductor materials such as germanium or a group III-V material or alloy. In further embodiments, one or more layers of metal and/or metal alloys may be used to form the S/D regions 1420.

Electrical signals, such as power and/or input/output (I/O) signals, may be routed to and/or from the devices (e.g., transistors 1440) of the device layer 1404 through one or more interconnect layers disposed on the device layer 1404 (illustrated in FIG. 14 as interconnect layers 1406-1410). For example, electrically conductive features of the device layer 1404 (e.g., the gate 1422 and the S/D contacts 1424) may be electrically coupled with the interconnect structures 1428 of the interconnect layers 1406-1410. The one or more interconnect layers 1406-1410 may form a metallization stack (also referred to as an “ILD stack”) 1419 of the integrated circuit device 1400.

The interconnect structures 1428 may be arranged within the interconnect layers 1406-1410 to route electrical signals according to a wide variety of designs; in particular, the arrangement is not limited to the particular configuration of interconnect structures 1428 depicted in FIG. 14. Although a particular number of interconnect layers 1406-1410 is depicted in FIG. 14, embodiments of the present disclosure include integrated circuit devices having more or fewer interconnect layers than depicted.

In some embodiments, the interconnect structures 1428 may include lines 1428a and/or vias 1428b filled with an electrically conductive material such as a metal. The lines 1428a may be arranged to route electrical signals in a direction of a plane that is substantially parallel with a surface of the die substrate 1402 upon which the device layer 1404 is formed. For example, the lines 1428a may route electrical signals in a direction in and out of the page and/or in a direction across the page. The vias 1428b may be arranged to route electrical signals in a direction of a plane that is substantially perpendicular to the surface of the die substrate 1402 upon which the device layer 1404 is formed. In some embodiments, the vias 1428b may electrically couple lines 1428a of different interconnect layers 1406-1410 together.

The interconnect layers 1406-1410 may include a dielectric material 1426 disposed between the interconnect structures 1428, as shown in FIG. 14. In some embodiments, dielectric material 1426 disposed between the interconnect structures 1428 in different ones of the interconnect layers 1406-1410 may have different compositions; in other embodiments, the composition of the dielectric material 1426 between different interconnect layers 1406-1410 may be the same. The device layer 1404 may include a dielectric material 1426 disposed between the transistors 1440 and a bottom layer of the metallization stack as well. The dielectric material 1426 included in the device layer 1404 may have a different composition than the dielectric material 1426 included in the interconnect layers 1406-1410; in other embodiments, the composition of the dielectric material 1426 in the device layer 1404 may be the same as a dielectric material 1426 included in any one of the interconnect layers 1406-1410.

A first interconnect layer 1406 (referred to as Metal 1 or “M1”) may be formed directly on the device layer 1404. In some embodiments, the first interconnect layer 1406 may include lines 1428a and/or vias 1428b, as shown. The lines 1428a of the first interconnect layer 1406 may be coupled with contacts (e.g., the S/D contacts 1424) of the device layer 1404. The vias 1428b of the first interconnect layer 1406 may be coupled with the lines 1428a of a second interconnect layer 1408.

The second interconnect layer 1408 (referred to as Metal 2 or “M2”) may be formed directly on the first interconnect layer 1406. In some embodiments, the second interconnect layer 1408 may include via 1428b to couple the lines 1428 of the second interconnect layer 1408 with the lines 1428a of a third interconnect layer 1410. Although the lines 1428a and the vias 1428b are structurally delineated with a line within individual interconnect layers for the sake of clarity, the lines 1428a and the vias 1428b may be structurally and/or materially contiguous (e.g., simultaneously filled during a dual-damascene process) in some embodiments.

The third interconnect layer 1410 (referred to as Metal 3 or “M3”) (and additional interconnect layers, as desired) may be formed in succession on the second interconnect layer 1408 according to similar techniques and configurations described in connection with the second interconnect layer 1408 or the first interconnect layer 1406. In some embodiments, the interconnect layers that are “higher up” in the metallization stack 1419 in the integrated circuit device 1400 (i.e., farther away from the device layer 1404) may be thicker that the interconnect layers that are lower in the metallization stack 1419, with lines 1428a and vias 1428b in the higher interconnect layers being thicker than those in the lower interconnect layers.

The integrated circuit device 1400 may include a solder resist material 1434 (e.g., polyimide or similar material) and one or more conductive contacts 1436 formed on the interconnect layers 1406-1410. In FIG. 14, the conductive contacts 1436 are illustrated as taking the form of bond pads. The conductive contacts 1436 may be electrically coupled with the interconnect structures 1428 and configured to route the electrical signals of the transistor(s) 1440 to external devices. For example, solder bonds may be formed on the one or more conductive contacts 1436 to mechanically and/or electrically couple an integrated circuit die including the integrated circuit device 1400 with another component (e.g., a printed circuit board). The integrated circuit device 1400 may include additional or alternate structures to route the electrical signals from the interconnect layers 1406-1410; for example, the conductive contacts 1436 may include other analogous features (e.g., posts) that route the electrical signals to external components. The conductive contacts 1436 may serve as the conductive contacts 302, as appropriate.

In some embodiments in which the integrated circuit device 1400 is a double-sided die, the integrated circuit device 1400 may include another metallization stack (not shown) on the opposite side of the device layer(s) 1404. This metallization stack may include multiple interconnect layers as discussed above with reference to the interconnect layers 1406-1410, to provide conductive pathways (e.g., including conductive lines and vias) between the device layer(s) 1404 and additional conductive contacts (not shown) on the opposite side of the integrated circuit device 1400 from the conductive contacts 1436. These additional conductive contacts may serve as the conductive contacts 302, as appropriate.

In other embodiments in which the integrated circuit device 1400 is a double-sided die, the integrated circuit device 1400 may include one or more through silicon vias (TSVs) through the die substrate 1402; these TSVs may make contact with the device layer(s) 1404, and may provide conductive pathways between the device layer(s) 1404 and additional conductive contacts (not shown) on the opposite side of the integrated circuit device 1400 from the conductive contacts 1436. These additional conductive contacts may serve as the conductive contacts 302, as appropriate. In some embodiments, TSVs extending through the substrate can be used for routing power and ground signals from conductive contacts on the opposite side of the integrated circuit device 1400 from the conductive contacts 1436 to the transistors 1440 and any other components integrated into the die 1400, and the metallization stack 1419 can be used to route I/O signals from the conductive contacts 1436 to transistors 1440 and any other components integrated into the die 1400.

Multiple integrated circuit devices 1400 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

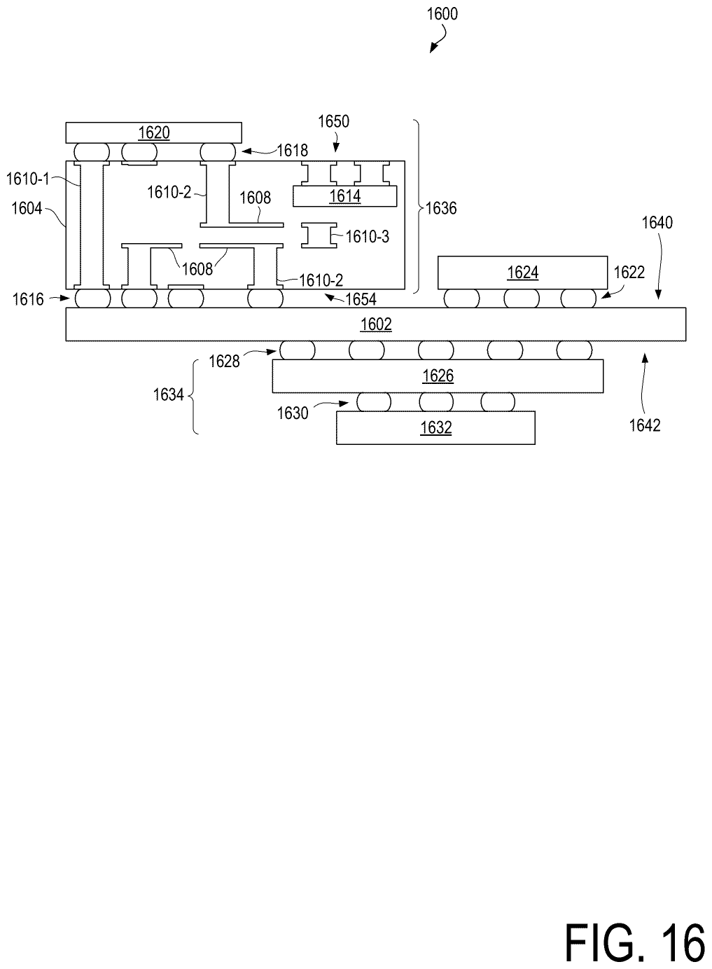

FIG. 16 is a cross-sectional side view of an integrated circuit device assembly 1600 that may include any of the systems 100 disclosed herein. In some embodiments, the integrated circuit device assembly 1600 may be a system 100. The integrated circuit device assembly 1600 includes a number of components disposed on a circuit board 1602 (which may be a motherboard, system board, mainboard, etc.). The integrated circuit device assembly 1600 includes components disposed on a first face 1640 of the circuit board 1602 and an opposing second face 1642 of the circuit board 1602; generally, components may be disposed on one or both faces 1640 and 1642. Any of the integrated circuit components discussed below with reference to the integrated circuit device assembly 1600 may take the form of any suitable ones of the embodiments of the systems 100 disclosed herein.

In some embodiments, the circuit board 1602 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1602. In other embodiments, the circuit board 1602 may be a non-PCB substrate. In some embodiments the circuit board 1602 may be, for example, the circuit board 114. The integrated circuit device assembly 1600 illustrated in FIG. 16 includes a package-on-interposer structure 1636 coupled to the first face 1640 of the circuit board 1602 by coupling components 1616. The coupling components 1616 may electrically and mechanically couple the package-on-interposer structure 1636 to the circuit board 1602, and may include solder balls (as shown in FIG. 16), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1616 may serve as the coupling components illustrated or described for any of the substrate assembly or substrate assembly components described herein, as appropriate.

The package-on-interposer structure 1636 may include an integrated circuit component 1620 coupled to an interposer 1604 by coupling components 1618. The coupling components 1618 may take any suitable form for the application, such as the forms discussed above with reference to the coupling components 1616. Although a single integrated circuit component 1620 is shown in FIG. 16, multiple integrated circuit components may be coupled to the interposer 1604; indeed, additional interposers may be coupled to the interposer 1604. The interposer 1604 may provide an intervening substrate used to bridge the circuit board 1602 and the integrated circuit component 1620.

The integrated circuit component 1620 may be a packaged or unpacked integrated circuit product that includes one or more integrated circuit dies (e.g., the die 1302 of FIG. 13, the integrated circuit device 1400 of FIG. 14) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1620, a single monolithic integrated circuit die comprises solder bumps attached to contacts on the die. The solder bumps allow the die to be directly attached to the interposer 1604. The integrated circuit component 1620 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1620 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1620 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1620 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1604 may spread connections to a wider pitch or reroute a connection to a different connection. For example, the interposer 1604 may couple the integrated circuit component 1620 to a set of ball grid array (BGA) conductive contacts of the coupling components 1616 for coupling to the circuit board 1602. In the embodiment illustrated in FIG. 16, the integrated circuit component 1620 and the circuit board 1602 are attached to opposing sides of the interposer 1604; in other embodiments, the integrated circuit component 1620 and the circuit board 1602 may be attached to a same side of the interposer 1604. In some embodiments, three or more components may be interconnected by way of the interposer 1604.

In some embodiments, the interposer 1604 may be formed as a PCB, including multiple metal layers separated from one another by layers of dielectric material and interconnected by electrically conductive vias. In some embodiments, the interposer 1604 may be formed of an epoxy resin, a fiberglass-reinforced epoxy resin, an epoxy resin with inorganic fillers, a ceramic material, or a polymer material such as polyimide. In some embodiments, the interposer 1604 may be formed of alternate rigid or flexible materials that may include the same materials described above for use in a semiconductor substrate, such as silicon, germanium, and other group III-V and group IV materials. The interposer 1604 may include metal interconnects 1608 and vias 1610, including but not limited to through hole vias 1610-1 (that extend from a first face 1650 of the interposer 1604 to a second face 1654 of the interposer 1604), blind vias 1610-2 (that extend from the first or second faces 1650 or 1654 of the interposer 1604 to an internal metal layer), and buried vias 1610-3 (that connect internal metal layers).

In some embodiments, the interposer 1604 can comprise a silicon interposer. Through silicon vias (TSV) extending through the silicon interposer can connect connections on a first face of a silicon interposer to an opposing second face of the silicon interposer. In some embodiments, an interposer 1604 comprising a silicon interposer can further comprise one or more routing layers to route connections on a first face of the interposer 1604 to an opposing second face of the interposer 1604.

The interposer 1604 may further include embedded devices 1614, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1604. The package-on-interposer structure 1636 may take the form of any of the package-on-interposer structures known in the art.

The integrated circuit device assembly 1600 may include an integrated circuit component 1624 coupled to the first face 1640 of the circuit board 1602 by coupling components 1622. The coupling components 1622 may take the form of any of the embodiments discussed above with reference to the coupling components 1616, and the integrated circuit component 1624 may take the form of any of the embodiments discussed above with reference to the integrated circuit component 1620.

The integrated circuit device assembly 1600 illustrated in FIG. 16 includes a package-on-package structure 1634 coupled to the second face 1642 of the circuit board 1602 by coupling components 1628. The package-on-package structure 1634 may include an integrated circuit component 1626 and an integrated circuit component 1632 coupled together by coupling components 1630 such that the integrated circuit component 1626 is disposed between the circuit board 1602 and the integrated circuit component 1632. The coupling components 1628 and 1630 may take the form of any of the embodiments of the coupling components 1616 discussed above, and the integrated circuit components 1626 and 1632 may take the form of any of the embodiments of the integrated circuit component 1620 discussed above. The package-on-package structure 1634 may be configured in accordance with any of the package-on-package structures known in the art.

FIG. 17 is a block diagram of an example electrical device 1700 that may include one or more of the systems 100 disclosed herein. For example, any suitable ones of the components of the electrical device 1700 may include one or more of the integrated circuit device assemblies 1600, integrated circuit components 1620, integrated circuit devices 1400, or integrated circuit dies 1302 disclosed herein, and may be arranged in any of the systems 100 disclosed herein. A number of components are illustrated in FIG. 17 as included in the electrical device 1700, but any one or more of these components may be omitted or duplicated, as suitable for the application. In some embodiments, some or all of the components included in the electrical device 1700 may be attached to one or more motherboards mainboards, or system boards. In some embodiments, one or more of these components are fabricated onto a single system-on-a-chip (SoC) die.

Additionally, in various embodiments, the electrical device 1700 may not include one or more of the components illustrated in FIG. 17, but the electrical device 1700 may include interface circuitry for coupling to the one or more components. For example, the electrical device 1700 may not include a display device 1706, but may include display device interface circuitry (e.g., a connector and driver circuitry) to which a display device 1706 may be coupled. In another set of examples, the electrical device 1700 may not include an audio input device 1724 or an audio output device 1708, but may include audio input or output device interface circuitry (e.g., connectors and supporting circuitry) to which an audio input device 1724 or audio output device 1708 may be coupled.

The electrical device 1700 may include one or more processor units 1702 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1702 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1700 may include a memory 1704, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1704 may include memory that is located on the same integrated circuit die as the processor unit 1702. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1700 can comprise one or more processor units 1702 that are heterogeneous or asymmetric to another processor unit 1702 in the electrical device 1700. There can be a variety of differences between the processing units 1702 in a system in terms of a spectrum of metrics of merit including architectural, microarchitectural, thermal, power consumption characteristics, and the like. These differences can effectively manifest themselves as asymmetry and heterogeneity among the processor units 1702 in the electrical device 1700.

In some embodiments, the electrical device 1700 may include a communication component 1712 (e.g., one or more communication components). For example, the communication component 1712 can manage wireless communications for the transfer of data to and from the electrical device 1700. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1712 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1712 may operate in accordance with other wireless protocols in other embodiments. The electrical device 1700 may include an antenna 1722 to facilitate wireless communications and/or to receive other wireless communications (such as AM or FM radio transmissions).

In some embodiments, the communication component 1712 may manage wired communications, such as electrical, optical, or any other suitable communication protocols (e.g., IEEE 802.3 Ethernet standards). As noted above, the communication component 1712 may include multiple communication components. For instance, a first communication component 1712 may be dedicated to shorter-range wireless communications such as Wi-Fi or Bluetooth, and a second communication component 1712 may be dedicated to longer-range wireless communications such as global positioning system (GPS), EDGE, GPRS, CDMA, WiMAX, LTE, EV-DO, or others. In some embodiments, a first communication component 1712 may be dedicated to wireless communications, and a second communication component 1712 may be dedicated to wired communications.

The electrical device 1700 may include battery/power circuitry 1714. The battery/power circuitry 1714 may include one or more energy storage devices (e.g., batteries or capacitors) and/or circuitry for coupling components of the electrical device 1700 to an energy source separate from the electrical device 1700 (e.g., AC line power).

The electrical device 1700 may include a display device 1706 (or corresponding interface circuitry, as discussed above). The display device 1706 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1700 may include an audio output device 1708 (or corresponding interface circuitry, as discussed above). The audio output device 1708 may include any embedded or wired or wirelessly connected external device that generates an audible indicator, such as speakers, headsets, or earbuds.

The electrical device 1700 may include an audio input device 1724 (or corresponding interface circuitry, as discussed above). The audio input device 1724 may include any embedded or wired or wirelessly connected device that generates a signal representative of a sound, such as microphones, microphone arrays, or digital instruments (e.g., instruments having a musical instrument digital interface (MIDI) output). The electrical device 1700 may include a Global Navigation Satellite System (GNSS) device 1718 (or corresponding interface circuitry, as discussed above), such as a Global Positioning System (GPS) device. The GNSS device 1718 may be in communication with a satellite-based system and may determine a geolocation of the electrical device 1700 based on information received from one or more GNSS satellites, as known in the art.

The electrical device 1700 may include an other output device 1710 (or corresponding interface circuitry, as discussed above). Examples of the other output device 1710 may include an audio codec, a video codec, a printer, a wired or wireless transmitter for providing information to other devices, or an additional storage device.

The electrical device 1700 may include an other input device 1720 (or corresponding interface circuitry, as discussed above). Examples of the other input device 1720 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1700 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1700 may be any other electronic device that processes data. In some embodiments, the electrical device 1700 may comprise multiple discrete physical components. Given the range of devices that the electrical device 1700 can be manifested as in various embodiments, in some embodiments, the electrical device 1700 can be referred to as a computing device or a computing system.

### EXAMPLES

Illustrative examples of the technologies disclosed herein are provided below. An embodiment of the technologies may include any one or more, and any combination of, the examples described below.

Example 1 includes an apparatus comprising a monolithic glass substrate comprising one or more waveguides defined in the glass substrate; and one or more lenses defined in the glass substrate, wherein individual lenses of the one or more lenses are to collimate light from individual waveguides of the one or more waveguides, wherein individual lenses of the one or more lenses are defined at least partly by a varying index of refraction in the monolithic glass substrate.

Example 2 includes the subject matter of Example 1, and wherein individual lenses of the one or more lenses are graded-index (GRIN) lenses.

Example 3 includes the subject matter of any of Examples 1 and 2, and wherein individual lenses of the one or more lenses are defined by a region with a fixed difference in index of refraction relative to a bulk of the glass substrate.

Example 4 includes the subject matter of any of Examples 1-3, and wherein the one or more waveguides comprises at least four waveguides.

Example 5 includes the subject matter of any of Examples 1-4, and further including a photonic integrated circuit (PIC) die mated with the glass substrate, wherein one or more waveguides are defined in the PIC die, wherein individual waveguides of the one or more waveguides of the glass substrate are butt coupled to individual waveguides of the one or more waveguides of the PIC die.

Example 6 includes the subject matter of any of Examples 1-5, and further including an electronic integrated circuit (EIC) die mated with the PIC die.

Example 7 includes the subject matter of any of Examples 1-6, and further including a circuit board, wherein the EIC die is mounted on the circuit board.

Example 8 includes the subject matter of any of Examples 1-7, and further including an optical receptacle, the optical receptacle comprising the glass substrate.

Example 9 includes the subject matter of any of Examples 1-8, and further including an optical plug mated with the optical receptacle, the optical plug comprising a second monolithic glass substrate comprising one or more cavities defined in the second glass substrate; and one or more lenses defined in the second glass substrate, and one or more optical fibers disposed in the one or more cavities, wherein individual lenses of the one or more lenses of the second glass substrate are to collimate light from individual optical fibers of the one or more optical fibers.

Example 10 includes the subject matter of any of Examples 1-9, and wherein one or more lenses in the glass substrate and the one or more lenses in the second glass substrate are to couple light from the one or more optical fibers to the one or more waveguides.

Example 11 includes an apparatus comprising a monolithic glass substrate comprising one or more cavities defined in the glass substrate; and one or more lenses defined in the glass substrate, and one or more optical fibers disposed in the one or more cavities, wherein individual lenses of the one or more lenses are to collimate light from individual optical fibers of the one or more optical fibers.

Example 12 includes the subject matter of Example 11, and wherein individual lenses of the one or more lenses are defined at least partly by a varying index of refraction in the monolithic glass substrate.

Example 13 includes the subject matter of any of Examples 11 and 12, and wherein individual lenses of the one or more lenses are graded-index (GRIN) lenses.

Example 14 includes the subject matter of any of Examples 11-13, and wherein individual lenses of the one or more lenses are defined by a region with a fixed difference in index of refraction relative to a bulk of the glass substrate.

Example 15 includes the subject matter of any of Examples 11-14, and wherein individual lenses of the one or more lenses are defined at least partly by a curved area of a surface of the monolithic glass substrate.

Example 16 includes the subject matter of any of Examples 11-15, and wherein the one or more optical fibers comprises at least four waveguides.

Example 17 includes the subject matter of any of Examples 11-16, and further including an optical plug, the optical plug comprising the glass substrate.

Example 18 includes the subject matter of any of Examples 11-17, and further including an optical receptacle mated with the optical plug, the optical receptacle comprising a second monolithic glass substrate comprising one or more waveguides defined in the second glass substrate; and one or more lenses defined in the second glass substrate, wherein individual lenses of the one or more lenses of the second glass substrate are to collimate light from individual waveguides of the one or more waveguides, wherein individual lenses of the one or more lenses of the second glass substrate are defined at least partly by a varying index of refraction in the monolithic glass substrate.

Example 19 includes the subject matter of any of Examples 11-18, and wherein one or more lenses in the glass substrate and the one or more lenses in the second glass substrate are to couple light from the one or more optical fibers to the one or more waveguides.

Example 20 includes a method comprising writing one or more waveguides in a glass substrate using a laser; forming a first set of one or more lenses and a second set of one or more lenses in the glass substrate using a laser; creating one or more cavities for an optical fiber in the glass substrate; and creating a seam in the glass substrate, wherein creating the seam comprises using a laser to prepare the seam for etching and etching the seam with an etchant, wherein the seam separates the glass substrate into a glass substrate for an optical plug and a glass substrate for an optical receptacle, wherein the glass substrate for the optical plug has the one or more cavities defined in it, wherein the glass substrate for the optical plug comprises the first set of one or more lenses, wherein individual lenses of the first set of one or more lenses are positioned to collimate light from optical fibers placed in a corresponding cavity of the one or more cavities, wherein the glass substrate for the optical receptacle has the one or more waveguides defined in it, wherein the glass substrate for the optical plug comprises the second set of one or more lenses, wherein individual lenses of the second set of one or more lenses are positioned to collimate light from individual waveguides of the one or more waveguides.

Example 21 includes the subject matter of Example 20, and wherein forming the first set of one or more lenses and the second set of one or more lenses comprises using the laser to write individual lenses of the first set of one or more lenses and the second set of one or more lenses to change an index of refraction of a region of the glass substrate.

Example 22 includes the subject matter of any of Examples 20 and 21, and wherein individual lenses of the first set of one or more lenses and the second set of one or more lenses are graded-index (GRIN) lenses.

Example 23 includes the subject matter of any of Examples 20-22, and wherein individual lenses of the first set of one or more lenses and the second set of one or more lenses are defined by a region with a fixed difference in index of refraction relative to a bulk of the glass substrate.

Example 24 includes the subject matter of any of Examples 20-23, and wherein individual lenses of the first set of one or more lenses are defined at least partly by a curved area of a surface of the glass substrate for the optical plug, wherein individual lenses of the second set of one or more lenses are defined at least partly by a curved area of a surface of the glass substrate for the optical receptacle.

1. An apparatus comprising:
a monolithic glass substrate comprising:
one or more waveguides defined in the glass substrate; and
one or more lenses defined in the glass substrate,
wherein individual lenses of the one or more lenses are to collimate light from individual waveguides of the one or more waveguides,
wherein individual lenses of the one or more lenses are defined at least partly by a varying index of refraction in the monolithic glass substrate.

2. The apparatus of claim 1, wherein individual lenses of the one or more lenses are graded-index (GRIN) lenses.

3. The apparatus of claim 1, wherein individual lenses of the one or more lenses are defined by a region with a fixed difference in index of refraction relative to a bulk of the glass substrate.

4. The apparatus of claim 1, wherein the one or more waveguides comprises at least four waveguides.

5. The apparatus of claim 1, further comprising a photonic integrated circuit (PIC) die mated with the glass substrate, wherein one or more waveguides are defined in the PIC die,
wherein individual waveguides of the one or more waveguides of the glass substrate are butt coupled to individual waveguides of the one or more waveguides of the PIC die.

6. The apparatus of claim 5, further comprising an electronic integrated circuit (EIC) die mated with the PIC die.

7. The apparatus of claim 6, further comprising a circuit board, wherein the EIC die is mounted on the circuit board.

8. The apparatus of claim 1, further comprising an optical receptacle, the optical receptacle comprising the glass substrate.

9. The apparatus of claim 8, further comprising an optical plug mated with the optical receptacle, the optical plug comprising:
a second monolithic glass substrate comprising:
one or more cavities defined in the second glass substrate; and
one or more lenses defined in the second glass substrate, and
one or more optical fibers disposed in the one or more cavities,
wherein individual lenses of the one or more lenses of the second glass substrate are to collimate light from individual optical fibers of the one or more optical fibers.

10. The apparatus of claim 9, wherein one or more lenses in the glass substrate and the one or more lenses in the second glass substrate are to couple light from the one or more optical fibers to the one or more waveguides.

11. An apparatus comprising:
a monolithic glass substrate comprising:
one or more cavities defined in the glass substrate; and
one or more lenses defined in the glass substrate, and
one or more optical fibers disposed in the one or more cavities,
wherein individual lenses of the one or more lenses are to collimate light from individual optical fibers of the one or more optical fibers.

12. The apparatus of claim 11, wherein individual lenses of the one or more lenses are defined at least partly by a varying index of refraction in the monolithic glass substrate.

13. The apparatus of claim 12, wherein individual lenses of the one or more lenses are graded-index (GRIN) lenses.

14. The apparatus of claim 12, wherein individual lenses of the one or more lenses are defined by a region with a fixed difference in index of refraction relative to a bulk of the glass substrate.

15. The apparatus of claim 11, wherein individual lenses of the one or more lenses are defined at least partly by a curved area of a surface of the monolithic glass substrate.

16. The apparatus of claim 11, further comprising an optical plug, the optical plug comprising the glass substrate.

17. A method comprising:
writing one or more waveguides in a glass substrate using a laser;
forming a first set of one or more lenses and a second set of one or more lenses in the glass substrate using a laser;
creating one or more cavities for an optical fiber in the glass substrate; and
creating a seam in the glass substrate, wherein creating the seam comprises using a laser to prepare the seam for etching and etching the seam with an etchant, wherein the seam separates the glass substrate into a glass substrate for an optical plug and a glass substrate for an optical receptacle,
wherein the glass substrate for the optical plug has the one or more cavities defined in it, wherein the glass substrate for the optical plug comprises the first set of one or more lenses, wherein individual lenses of the first set of one or more lenses are positioned to collimate light from optical fibers placed in a corresponding cavity of the one or more cavities,
wherein the glass substrate for the optical receptacle has the one or more waveguides defined in it, wherein the glass substrate for the optical plug comprises the second set of one or more lenses, wherein individual lenses of the second set of one or more lenses are positioned to collimate light from individual waveguides of the one or more waveguides.

18. The method of claim 17, wherein forming the first set of one or more lenses and the second set of one or more lenses comprises using the laser to write individual lenses of the first set of one or more lenses and the second set of one or more lenses to change an index of refraction of a region of the glass substrate.

19. The method of claim 18, wherein individual lenses of the first set of one or more lenses and the second set of one or more lenses are graded-index (GRIN) lenses.

20. The method of claim 18, wherein individual lenses of the first set of one or more lenses and the second set of one or more lenses are defined by a region with a fixed difference in index of refraction relative to a bulk of the glass substrate.
